(19) United States
(12) Patent Application Publication
(10) Pub. No.: US 2007/0267507 A1
(43) Pub. Date: Nov. 22, 2007

(54) System for Digital Writing

(75) Inventor: Franciscus Koenraad Diederik Maria Hartmann, Utrecht (NL)

Correspondence Address: MICHAELSON & ASSOCIATES, P.O. BOX 8489, RED BANK, NJ, 07701, US

(73) Assignee: Koninklijke KPN N.V.,, The Hague (NL)

(21) Appl. No.: 11/793,663

(22) PCT Filed: Jan. 13, 2006
(86) PCT No.: PCT/EP06/00376

§ 371 Date: Jun. 20, 2007

Related U.S. Application Data
(60) Provisional application No. 60/646,074, filed on Jan. 21, 2005.

(51) Int. Cl. G06F 17/00

(52) U.S. Cl. 235/494

(57) ABSTRACT

A digital writing system for providing handwritten information to a computer system application is disclosed. The digital writing system can comprise an electronic display and a digital writing and scanning device capable of detecting its position based on a position-coding pattern. This position-coding pattern is superimposed on the surface of the electronic display.

### FIELD OF THE INVENTION

The present invention is related to communication systems. More specifically, a system for digital writing is disclosed.

### BACKGROUND OF THE INVENTION

Since several years digital writing systems are available on the market. These systems usually comprise a dedicated pen including a normal ink pen, a camera and a means of communicating with external devices, e.g. via Bluetooth. The pen is used to write on a special piece of paper, which contains a unique specific pattern of small dots, a so-called position-coding pattern. Some available systems are based on technology developed by Anoto AB from Sweden. This technology is disclosed in a number of patents, e.g. WO0126032A1. The position-coding pattern can be printed on a variety of general or specially developed paper products, e.g. note blocks or forms.

With this combination of pen, paper and communication means a wide range of applications can be developed. These applications can include handwriting recognition software and additional functionality.

WO2005/010634 e.g. discloses a digital writing system that captures handwritten gestures in addition to text and patterns.

However a problem of these existing systems is that the special paper is the only available means for input. The pen writes actual ink on it, so the paper is not usable afterwards, and for dedicated business applications a new dedicate paper format and product has to be developed.

Also on the market are devices with a touch sensitive screen, like e.g. built in in tablet PC's. The screens of these devices are reusable and flexible in a sense that they can be used for different applications. However these devices and screens are relatively expensive and need to be specifically adapted and made suitable for communication by touching the surface, e.g. with an accompanying pen. The facility to communicate by touching the screen with a pen also deteriorates the quality of the screen as a display.

Problem Definition

Thus the prior art fails to disclose an easy to implement system for flexible and reusable means to use with a digital pen.

Aim of the Invention

The aim of the invention is to provide a solution for the above-mentioned problems of the prior art, and to provide a flexible and reusable means to use with a digital pen.

### SUMMARY OF THE INVENTION

The invention provides a solution for providing handwritten information to a computer system application.

According to one aspect of the invention a digital writing system for providing handwritten information to a computer system application is disclosed. The digital writing system can comprise an electronic display and a digital writing and scanning device capable of detecting its position based on a position-coding pattern. This position-coding pattern is superimposed on the surface of the electronic display. The digital writing system according to the invention can be implemented in a desktop PC system, but also in laptop, notebook, palmtop, a tablet PC or any other computing system. Also a small device like a PDA can be used to implement the system. The digital writing and scanning device can have the form of a digital pen, but can also have any other form convenient for the user and the application. The scanning device could be a pen like device that has a camera inside to read the code. Furthermore a source of light can be included to light up the surface of the screen. The used light need not be in the visual range. Preferably not, since this might disturb the readability of the screen. The electronic display device can be of any type, including but not limited to TFT, LCD, Television, OLED etc. Superimposing the location-coding pattern on the electronic display has the advantage that the display can be used as input means for the computer without the need to physically adapt the screen. Another advantage is that the pattern can be used for different kinds of application without the need to develop dedicated paper forms. Because there is no ink applied to the pattern the pattern remains reusable for the next application. The location-coding pattern that is superimposed on the surface of the display device can exist of a pattern of small marks. The marks form a unique grid over the total surface of the screen. These marks can be applied to the screen with printing techniques or any other means differentiating small parts of the surface. The difference between the surface and the marks can e.g. exist in differences in colour, brightness, reflectivity etc. Preferably the marks are not visible with the human eye. This has the advantage that the vision of the screen is not deteriorated. The code can also be placed on a more or less transparent sheet that can be applied to the electronic display device. This has the advantage that the system can be used without any adaptations to an existing display device.

According to another aspect of the invention an electronic display is disclosed the display comprising a position coding pattern superimposed on its surface.

### BRIEF DESCRIPTION OF THE DRAWINGS

The invention will be explained in greater detail by reference to exemplary embodiments shown in the drawing, in which:

FIG. 1 schematically shows an exemplary system according to the invention.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice without departing from the true spirit of the invention, the scope of the invention being only limited by the claims as finally granted.

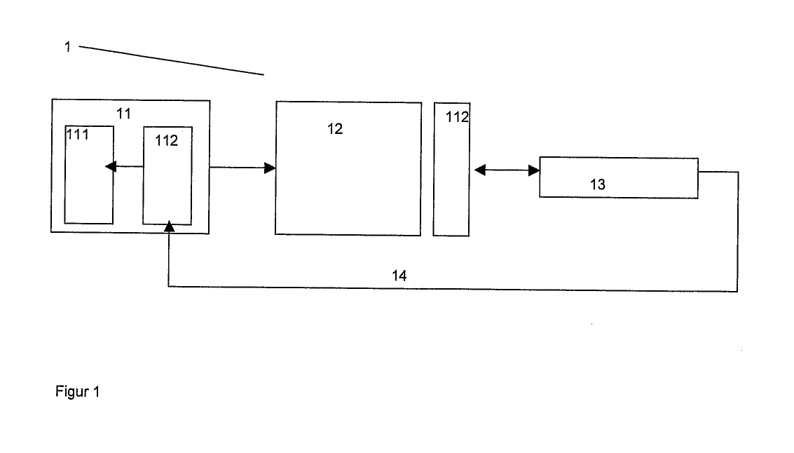

The digital writing system (1) according to an embodiment of the invention comprises a CPU (11) an electronic display device (12) and an electronic writing and scanning device (13). The system according to the invention can also comprise other elements, e.g. a keyboard and a printer, but these elements are less relevant for explaining the invention and therefore not depicted in FIG. 1.

This embodiment of the invention is implemented in a desktop PC like configuration but could also be implemented in another system or device. On the CPU (11) different applications (111) can be executed, e.g. word-processing, spreadsheet, Internet or form filling applications. The CPU (11) also comprises the digital writing software (112) necessary to receive, interpret and display the input sent by the electronic writing and scanning device (13). The electronic writing and scanning device (13) in this embodiment is a digital pen, known in the prior art, comprising elements like a camera, internal memory and means for communicating the scanned information. Unlike some known digital pens, the writing and scanning device according to the invention does not write with actual ink, or has the means to disable the writing with ink. According to the invention a position-coding pattern (122) is applied to the screen. The pattern comprises of marks, forming a unique grid on the surface. The pattern can be invisible for the user. The user uses the writing and scanning device (13) for making handwriting movements and other gestures over the position-coding pattern (122) on the display device (12). The writing and scanning device (13) continually scans the pattern on the display device (12) and recognizes his position on the surface and communicates (14) its position on the location-coding pattern to the digital writing software (112) that passes the input to the application (111). The writing and scanning device (13) can communicate the information via any existing or future communication technique (WiFi, Bluetooth, infrared, etc.). The electronic display device (12) functions just like the paper in known digital writing applications, but without the need for a complex and expensive touch sensitive display. Depending on the application (111) that is running on the computer data is provided to the application, and next the handwriting or hand gestures might be recognized and translated into digital information. The electronic display will first show the handwriting or gestures made by the user. After an instruction by the user, the digital writing software (112) will translate the handwriting and gestures into digital information and display the information in a different format on the display.

For example an empty or partly filled spreadsheet can be presented to the user via the electronic display. The user can fill in the spreadsheet with handwritten numbers, and after filling all available information the user can instruct the system to translate the numbers into digital numbers and update the spreadsheet. So the screen functions as the paper in existing digital writing systems.

1. Digital writing system for providing handwritten information to a computer system application comprising an electronic display, wherein said position coding pattern is superimposed on the surface of said electronic display.

2. The system of claim 1, wherein the coding pattern comprises marks that are not visible for the human eye.

3. The system of claim 1, wherein the coding pattern is applied to a separate sheet, which is superimposed on the electronic display device.

4. An electronic display comprising a position coding pattern superimposed on its surface.

5. The system of claim 2, wherein the coding pattern is applied to a separate sheet, which is superimposed on the electronic display device.
